(19) United States
(12) Patent Application Publication
(10) Pub. No.: US 2014/0071062 A1
(43) Pub. Date: Mar. 13, 2014

(54) METHOD FOR INCREASING TOUCH SAMPLING RATE AND TOUCH DISPLAY DEVICE USING THE SAME

(71) Applicant: Chung-Yin Fang, Hsinchu (TW)

(72) Inventor: Chung-Yin Fang, Hsinchu (TW)

(73) Assignee: SILICON INTEGRATED SYSTEMS CORP., Hsinchu (TW)

(21) Appl. No.: 13/614,890

(22) Filed: Sep. 13, 2012

(51) Int. Cl. G06F 3/041

(52) U.S. Cl. 345/173

(57) ABSTRACT

A method for increasing touch sampling rate and a touch display device using the same are provided, wherein the touch display device comprises a timing controller and a display panel. A timing control signal is provided by the timing controller. Each cycle of the timing control signal comprises a blanking period and a frame period, every N frame periods correspond to one image frame of a video signal, and every N blanking periods and every N frame periods correspond to one cycle of the video signal, where N is a positive integer larger than 1. Through the timing control signal, the touch display device arranges the timing for driving the display panel to display frame images and to sense touch, whereby increasing the touch sampling rate thereof.

### BACKGROUND

1. Technical Field

The disclosure relates to a touch display device, and more particularly to a method for increasing touch sampling rate and a touch display device using the same.

2. Related Art

Generally, the touch display device comprises an integrated display panel and a controller. The integrated display panel is fabricated with a LCD panel and a touch panel.

The controller generates a timing control signal TS1 shown in FIG. 1 based on the specification of the touch display device and outputs the timing control signal TS1 to the integrated display panel. The integrated display panel displays image frames of the video signal according to the timing control signal TS1. The touch panel is driven according to the timing control signal TS1 to sense touch.

The LCD panel comprises a gate driver and a data driver. The gate driver generates a gate signal according to the timing control signal TS1. The data driver generates a data signal according to the timing control signal TS1. Through both the gate signal and the data signal, hereinafter “driving signal,” the gate driver controls each pixel of the integrated display panel to turn on or off, and the data driver controls the brightness of each pixel of the integrated display panel.

More specifically, the timing control signal TS1 includes multiple cycles, e.g. a first cycle and a second cycle in FIG. 1. Each cycle of the timing control signal TS1 includes a frame period, e.g. a first frame period D1 or a second frame period D2, and a blanking period, e.g. a first blanking period T1, a second blanking period T2 or a third blanking period T3. One frame period corresponds to one image frame of the video signal. One blanking period and one frame period correspond to one cycle of the video signal. For an example of a frame rate of 60 frames/sec, one cycle of the video signal is 1/60 sec.

In the first blanking period T1, the touch panel is driven to sense touch. In the first frame period D1, the LCD panel is driven to display one image frame of the video signal. In the second blanking period T2, the touch panel is driven to sense touch again. In the second frame period D2, the LCD panel is driven to display a next image frame of the video signal.

However, the touch sampling rate of the touch circuit of such a touch display device is limited by a frame rate of the video signal. Based on the frame rate of 60 frames/sec, the integrated display panel may perform the sensing touch around 60 times per second. When a finger of a user slides on the integrated display panel very fast, it may become more difficult to determine a track accurately.

### SUMMARY

The disclosure provides a method for increasing touch sampling rate, which is adapted to a touch display device comprising a timing controller and a display panel. A timing control signal is provided by the timing controller. Each cycle of the timing control signal comprises a blanking period and a frame period. Every N frame periods correspond to one image frame of a video signal, where N is a positive integer larger than 1. Every N blanking periods and every N frame periods correspond to one cycle of the video signal.

Alternately, the display panel is driven in the ith frame period to display an ith part of an image data of one image frame and is driven in the ith blanking period to sense touch, where i is set in order from of 1 to N.

The disclosure provides a touch display device comprising a timing controller and a display panel and performing a method for increasing touch sampling rate. A timing control signal is provided by the timing controller. Each cycle of the timing control signal comprises a blanking period and a frame period. Every N frame periods correspond to one image frame of a video signal, where N is a positive integer larger than 1. Every N blanking periods and every N frame periods correspond to one cycle of the video signal.

Alternately, the display panel is driven in the ith frame period to display an ith part of an image data of one image frame and is driven in the ith blanking period to sense touch, where i is set in order from 1 to N.

For purposes of summarizing, some aspects, advantages and features of some embodiments of the disclosure have been described in this summary. Not necessarily all of (or any of) these summarized aspects, advantages or features will be embodied in any particular embodiment of the disclosure. Some of these summarized aspects, advantages and features and other aspects, advantages and features may become more fully apparent from the following detailed description and the appended claims.

### BRIEF DESCRIPTION OF THE DRAWINGS

The disclosure will become more fully understood from the detailed description given herein below for illustration only, and thus are not limitative of the disclosure, and wherein:

FIG. 1 is a sequence diagram of a touch display device according to the previous art;

FIG. 2 is a block diagram of a touch display device according to an embodiment of the disclosure;

FIG. 3 is a sequence diagram of the touch display device of the implementation of FIG. 2;

FIG. 4A and FIG. 4B are schematic diagrams of image frames displayed by the touch display device of the implementation of FIG. 2; and

FIG. 5 is a flow chart of the operation of the touch display device of the implementation of FIG. 2.

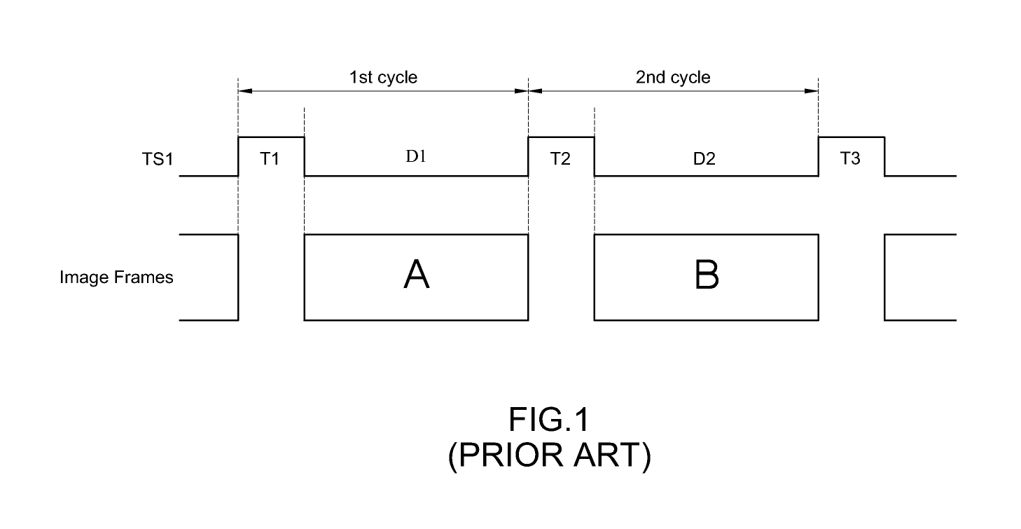

### DETAILED DESCRIPTION

The detailed features and advantages of the disclosure are described below in great detail through the following embodiments, the content of which is sufficient for those of ordinary skill in the art to understand the technical content of the disclosure and to implement the disclosure accordingly. Based upon the content of the specification, the claims, and the drawings, those of ordinary skill in the art can easily understand the relevant objectives and advantages of the disclosure.

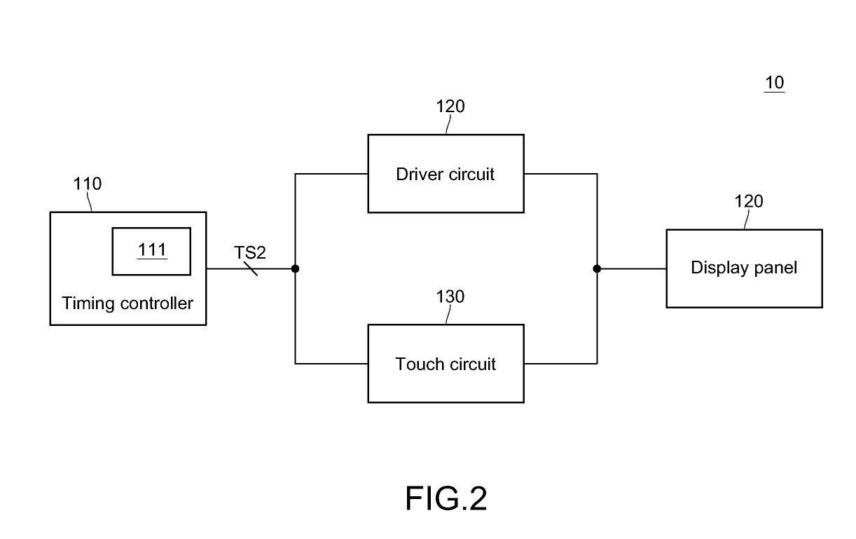

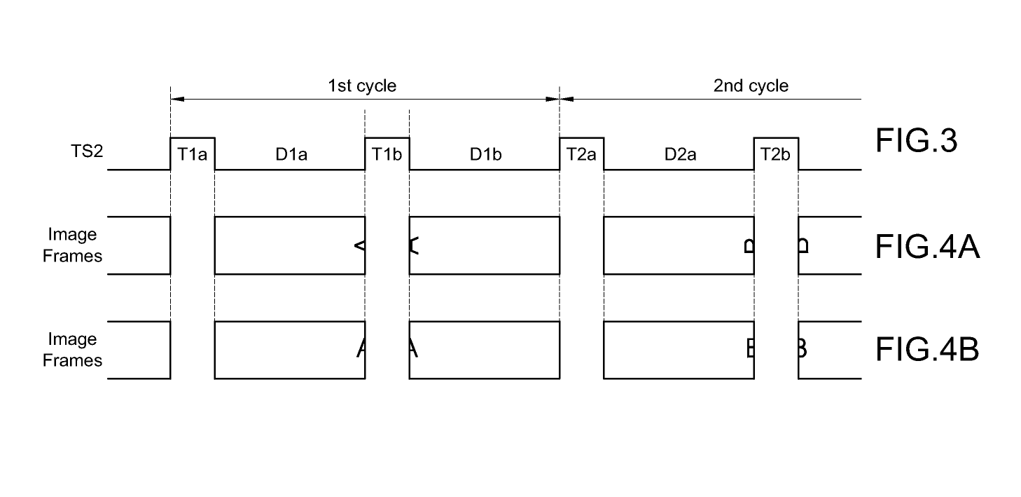

Referring to FIG. 2 and FIG. 3, FIG. 2 illustrates a block diagram of the touch display device according to an embodiment of the disclosure, and FIG. 3 illustrates a sequence diagram of a touch display device of the implementation of FIG. 2. The touch display device 10 includes a timing controller 110, a driver circuit 120, a touch circuit 130 and a display panel 140. The timing controller 110 communicates with the driver circuit 120 and the touch circuit 130. The driver circuit 120 and the touch circuit 130 respectively communicate with the display panel 140.

The timing controller 110 includes a buffer unit 111. The timing controller 110 divides the image data of each image frame of a video signal into multiple parts. The frame rate of the video signal is fixed. When one of the multiple parts of the image data is displayed, other parts of the multiple parts of the image data are preserved in the buffer unit 111. Moreover, the timing controller 110 outputs a timing control signal TS2 to the driver circuit 120 and the touch circuit 130 respectively. The driver circuit 120 drives the display panel 140 to display image frames of a video signal according to the timing control signal TS2, that is, generates a driving signal according to the timing control signal TS2 and drives the display panel 140 according to the driving signal. The touch circuit 130 drives the display panel 140 to sense any touch occurs on the display panel 140, that is, generates a sensing driving signal according to the timing control signal TS2 and drives the display panel 140 according to the sensing driving signal. Notice that the display panel 140 performs the touch sensing and the image displaying asynchronously. While the display panel 140 performs the image displaying, the touch sensing is paused. While the display panel 140 performs the touch sensing, the image displaying is paused. The detail of the timing control signal TS2 is described as below.

The timing control signal TS2 includes multiple cycles, e.g. a first cycle and a second cycle, and each cycle of the timing control signal TS2 includes a frame period, e.g. the first frame period D1a, the first frame period D2a or a second frame period D1b, and a blanking period, e.g. the first blanking period T1a, the first blanking period T2a, the second blanking period T1b or the second blanking period T2b. Multiple frame periods correspond to one image frame. Multiple blanking periods and multiple frame periods correspond to one cycle of the video signal. The amount of the multiple frame periods and the amount of the multiple blanking periods are equal and based on application requests.

In one embodiment of a double touch sampling rate which is the double of the frame rate of the video signal, the image data of each image frame of the video signal is divided into a first part and a second part. Herein, every two frame periods (shown as D1a and D1b) correspond to each image frame of the video signal, and every two frame periods and every two blanking periods (shown as the first blanking period T1a and the second blanking period T1b or as the first blanking period T2a and the second blanking period T2b) correspond to each cycle of the video signal. The detail of the operation among the driving circuit 120, the touch circuit 130 and the display panel 140 are described as below.

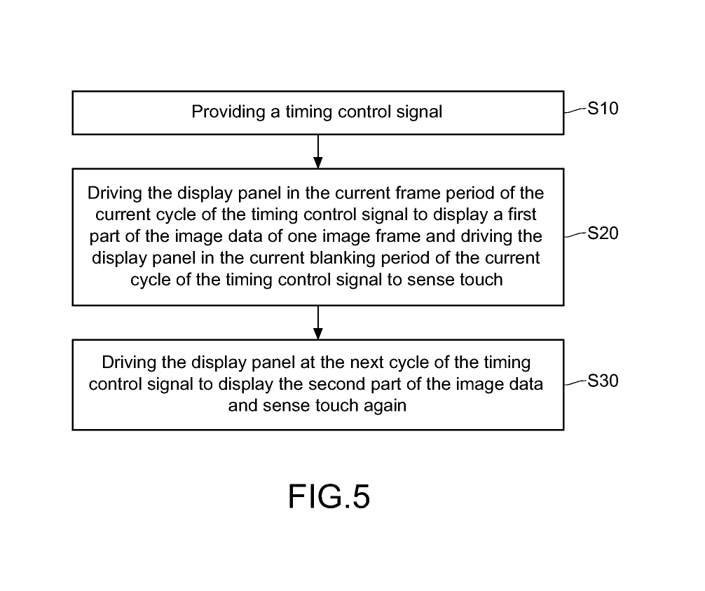

FIG. 5 is a flow chart of the operation of the touch display device of the implementation of FIG. 2. After the timing controller 110 outputs the timing control signal TS2 (shown in step S10), the touch circuit 130 outputs the sensing driving signal to the display panel 140 in the first blanking period T1a, and the display panel 140 senses touch according to the sensing driving signal (shown in step S20). After the first blanking period T1a, the driver circuit 120 outputs the driving signal to the display panel 140 in the first frame period D1a, and the display panel 140 displays the first part of one image frame according to the driving signal (shown in step S20). Subsequently, the touch circuit 130 outputs the sensing driving signal to the display panel 140 again in the second blanking period T1b, and the display panel 140 senses touch again (shown in step S30). After the second blanking period T1b, the driver circuit 120 outputs the driving signal to the display panel 140 again in the second frame period D1b, and the display panel 140 displays the second part of the image frame (shown in step S30).

More practically, the timing controller 110 may control both of the driver circuit 120 and the touch circuit 130 by the timing control signal TS2 in different ways. In one embodiment shown in FIG. 4A, the driver circuit 120 in order drives each column pixel line of the display panel 140 every frame period to display one partial image data, e.g. the first or second part of the image data, of one image frame, and the touch circuit 130 drives the display panel 140 every blanking period to sense any touch occurs. Herein, the first and second parts of the image data are column line data groups. In another embodiment shown in FIG. 4B, the driver circuit 120 in order drives each row pixel line of the display panel 140 every frame period to display one partial image data of one image frame, and the touch circuit 130 every blanking period drives the display panel 140 to sense any touch occurs. Herein, the first and second parts of the image data are row line data groups.

Thus, the image data of each image frame may be divided in different ways. In one embodiment, the image frame is divided vertically. In another embodiment, the image frame is divided horizontally.

Besides, the display panel 140 may provide a common path for the driving signal and the sensing driving signal. While the driver circuit 120 transmits the driving signal to the display panel 140 through the common path, the touch circuit 130 is paused to transmit the sensing driving signal to the display panel 140. Contrariwise, while the touch circuit 130 transmits the sensing driving signal to the display panel 140 through the common path, the driver circuit 120 is paused to transmit the driving signal to the display panel 140.

Accordingly, through the timing control signal, the disclosure arranges the timing for driving the display panel to display frame images and to sense touch, whereby increasing the touch sampling rate of the touch display device.

The disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for increasing touch sampling rate, adapted to a touch display device comprising a timing controller and a display panel, and comprising:
providing a timing control signal by the timing controller, wherein each cycle of the timing control signal comprises a blanking period and a frame period, every N frame periods correspond to one image frame of a video signal, every N blanking periods and every N frame periods correspond to one cycle of the video signal, and N is a positive integer larger than 1; and
alternately, driving the display panel in the ith frame period to display a ith part of an image data of the image frame, and driving the display panel in the ith blanking period to sense touch, where i is set in order from 1 to N.

2. The method for increasing touch sampling rate according to claim 1, wherein the step of driving the display panel in the ith frame period to display the ith part of the image data comprises:
generating a driving signal according to the timing control signal; and
transmitting the driving signal to the display panel.

3. The method for increasing touch sampling rate according to claim 2, wherein the step of driving the display panel in the ith blanking period to sense touch comprises:
generating a sensing driving signal according to the timing control signal; and
transmitting the sensing driving signal to the display panel.

4. The method for increasing touch sampling rate according to claim 3, wherein the driving signal and the sensing driving signal are transmitted to the display panel alternately.

5. The method for increasing touch sampling rate according to claim 1, further comprising:
preserving the image data.

6. The method for increasing touch sampling rate according to claim 1, further comprising:
dividing the image data of the image frame into the N parts.

7. The method for increasing touch sampling rate according to claim 1, wherein the N parts of the image data are column line data groups.

8. The method for increasing touch sampling rate according to claim 1, wherein the N parts of the image data are row line data groups.

9. A touch display device comprising a timing controller and a display panel and performing a method for increasing touch sampling rate, wherein the method comprises:
providing a timing control signal by the timing controller, wherein each cycle of the timing control signal comprises a blanking period and a frame period, every N frame periods correspond to one image frame of a video signal, every N blanking periods and every N frame periods correspond to one cycle of the video signal, and N is a positive integer larger than 1; and
alternately, driving the display panel in the ith frame period to display a ith part of an image data of the image frame, and driving the display panel in the ith blanking period to sense touch, where i is set in order from 1 to N.

10. The touch display device according to claim 9, wherein the method further comprises:
preserving the image data.

11. The touch display device according to claim 9, wherein the step of driving the display panel in the ith frame period to display the ith part of the image data comprises:
generating a driving signal according to the timing control signal; and
transmitting the driving signal to the display panel.

12. The touch display device according to claim 11, wherein the step of driving the display panel in the ith blanking period to sense touch comprises:
generating a sensing driving signal according to the timing control signal; and
transmitting the sensing driving signal to the display panel.

13. The touch display device according to claim 12, wherein the driving signal and the sensing driving signal are transmitted to the display panel alternately.

14. The touch display device according to claim 9, wherein the method further comprises:
dividing the image data of the image frame into the N parts.

15. The touch display device according to claim 9, wherein the N parts of the image data are column line data groups.

16. The touch display device according to claim 9, wherein the N parts of the image data are row line data groups.

17. The touch display device according to claim 9, further comprising:
a driver circuit, for communicating with the timing controller and the display panel and driving the display panel to display the image data according to the timing control signal; and
a touch circuit, communicating with the timing controller and the display panel and, according to the timing control signal, driving the display panel to sense touch.

18. The touch display device according to claim 9, wherein the timing controller comprising:
a buffer unit, for preserving the image data.
